(19) United States
(12) Patent Application Publication
(10) Pub. No.: US 2018/0110674 A1
(43) Pub. Date: Apr. 26, 2018

(54) PORTABLE NECK TREATMENT DEVICE

(71) Applicant: UNIVERSITY OF PETRA, Amman (JO)

(72) Inventors: Abedal-kareem M. Albanna, Amman (JO); Majed Naser Albanna, Amman (JO); Ghassan F. Issa, Amman (JO); Sanad Mohammad Omar Barjawi, Amman (JO); Ghiath MHD Kheir Eriksousi, Amman (JO); Tamara Aljuboori, Amman (JO)

(21) Appl. No.: 15/725,873

(22) Filed: Oct. 5, 2017

Related U.S. Application Data
(60) Provisional application No. 62/410,406, filed on Oct. 20, 2016.

(51) Int. Cl. A61H 7/00; G06F 19/00

(52) U.S. Cl. CPC A61H 7/003; A61H 1/0296; G06F 19/3418; A61H 7/004

(57) ABSTRACT

A portable neck treatment device that can apply physical exercises to a patient's neck, wherein the device includes a back support, a first shoulder engaging portion connected to the back support, a second shoulder engaging portion connected to the back support, a head pad extending from the back support with a front surface and a back surface, a jaw brace mechanically connected to at least one rotary actuator using a suitable coupling mechanism, and to two or more linear actuators, a vibrator, one or more heating elements, a patient user interface, and a remote user interface, wherein the at least one rotary actuator, the two or more linear actuators, the vibrator, the one or more heating elements, and the patient and remote user interfaces are operably connected to a controller module and a power source.

This application claims priority to U.S. provisional patent application Ser. No. 62/410,406 filed Oct. 20, 2016, which is hereby incorporated by reference herein.

### TECHNICAL FIELD

The present disclosure relates to the field of therapeutic devices, and more particularly to portable therapeutic devices that can alleviate neck pain associated with cervical disc.

### BACKGROUND

Neck pain has been a serious problem for society in the last decade. It is estimated that 30-50% of people worldwide suffer from cervical disc-related pain, or are susceptible to it.

There are several neck pains like cervical disc herniation, which need physical therapy. One of the most needed and common therapies is cervical traction, which is a nonsurgical treatment that alleviates pain by opening up the cervical foramen to reduce pressure on compressed nerve roots exiting the spinal canal.

Several devices have been introduced to help in that physical therapy, but those are costly, not automated, and do not cover the whole required treatment; many of these devices are not easy to use and need extra effort from the patient.

### SUMMARY

Aspects of the present disclosure provide a portable neck treatment device that helps in alleviating neck pain associated with cervical disc, which is automated and can be pre-programmed remotely.

Aspects of the present disclosure provide a portable neck treatment device that can apply physical exercises to a patient's neck. The device includes a back support; a first shoulder engaging portion connected to the back support; a second shoulder engaging portion connected to the back support; a head pad extending from the back support with a front surface and a back surface; a jaw brace mechanically connected to at least one rotary actuator using a suitable coupling mechanism, and to two or more linear actuators; a patient user interface; and a remote user interface, wherein the at least one rotary actuator, the two or more linear actuators, the vibrator, the one or more heating elements, and the patient and remote user interfaces are operably connected to a controller module.

The device may also include a vibrator, one or more heating elements, and a power source. The power source may provide adequate power to operate the controller module, the at least one rotary actuator, the two or more linear actuators, the vibrator, and the one or more heating elements.

In aspects of the present disclosure, the back support supports a substantial part of a patient's back.

In aspects of the present disclosure, each of the first and second shoulder engaging portions contacts a patient's shoulders, and includes a respective strap that covers a substantial part of a patient's chest during a therapeutic session. The straps may have fastening means.

In aspects of the present disclosure, the jaw brace encounters a patient's lower jaw, and the at least one rotary actuator and the two or more linear actuators cause confined movement of the jaw brace.

In aspects of the present disclosure, the at least one rotary actuator comprises a stepper motor.

In aspects of the present disclosure, the two or more linear actuators comprise hydraulic reciprocating cylinders.

In aspects of the present disclosure, the suitable coupling mechanism includes a pulley with a first groove and a second groove, the pulley is connected a shaft of the at least one rotary actuator; a first cable connected to the first groove and to a right hand side of the jaw brace; and a second cable connected to the second groove and to a left-hand side of the jaw brace.

In aspects of the present disclosure, the rotation of the pulley pulls either one of the first cable and the second cable.

In aspects of the present disclosure, the vibrator and the one or more heating elements are positioned at the rear surface of the head pad.

In aspects of the present disclosure, the remote user interface is operably connected to the controller module via the internet module over a first network.

In aspects of the present disclosure, the patient user interface is operably connected to the controller module via the internet module over a first network.

In aspects of the present disclosure, the patient user interface is operably connected to the controller module via the wireless module over a second network.

In aspects of the present disclosure, the second network comprises a Bluetooth network.

In aspects of the present disclosure, the second network includes a Wi-Fi network.

In aspects of the present disclosure, the wireless module includes a Bluetooth module.

In aspects of the present disclosure, the wireless module includes a Wi-Fi module.

In aspects of the present disclosure, the controller module is configured to send and receive signals from the patient user interface and the remote user interface.

In aspects of the present disclosure, the controller module is configured to send operation control signals to the at least one rotary actuator, the two or more linear actuators, the vibrator, and the one or more heating elements.

In aspects of the present disclosure, the remote user interface enables a physiotherapist, or other medical professional, to pre-program the controller module, set up a treatment plan and duration, and review a patient's feedback on a treatment session.

In aspects of the present disclosure, the patient user interface enables a patient to control an operation state of the device, and remotely send feedback on a treatment session, such as to a physiotherapist, or other medical professional.

### BRIEF DESCRIPTION OF THE DRAWINGS

The disclosure will now be described with reference to the accompanying drawings, which illustrate embodiments of the present disclosure without restricting the scope thereof, and in which:

FIG. 1 illustrates a frontal perspective view of a portable neck treatment device configured in accordance with embodiments of the present disclosure.

FIG. 2 illustrates a rear perspective view of a portable neck treatment device configured in accordance with embodiments of the present disclosure.

FIG. 3 illustrates a block diagram configured in accordance with embodiments of the present disclosure.

FIG. 4 illustrates a block diagram configured in accordance with other embodiments of the present disclosure.

FIG. 5 illustrates a flowchart diagram of a process for setting up a treatment plan and/or exercises to download to the portable neck treatment device in accordance with embodiments of the present disclosure.

FIG. 6 illustrates a flowchart diagram of a process for providing feedback from the portable neck treatment device to a remote user in accordance with embodiments of the present disclosure.

FIG. 7 illustrates a block diagram of a data processing system configured in accordance with embodiments of the present disclosure.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description is not intended to limit the scope of the invention, as claimed, but is presented for purposes of illustration only to describe the features and characteristics of the present invention, and to sufficiently enable one skilled in the art to practice the invention. Accordingly, the scope of the present invention is to be defined solely by the appended claims.

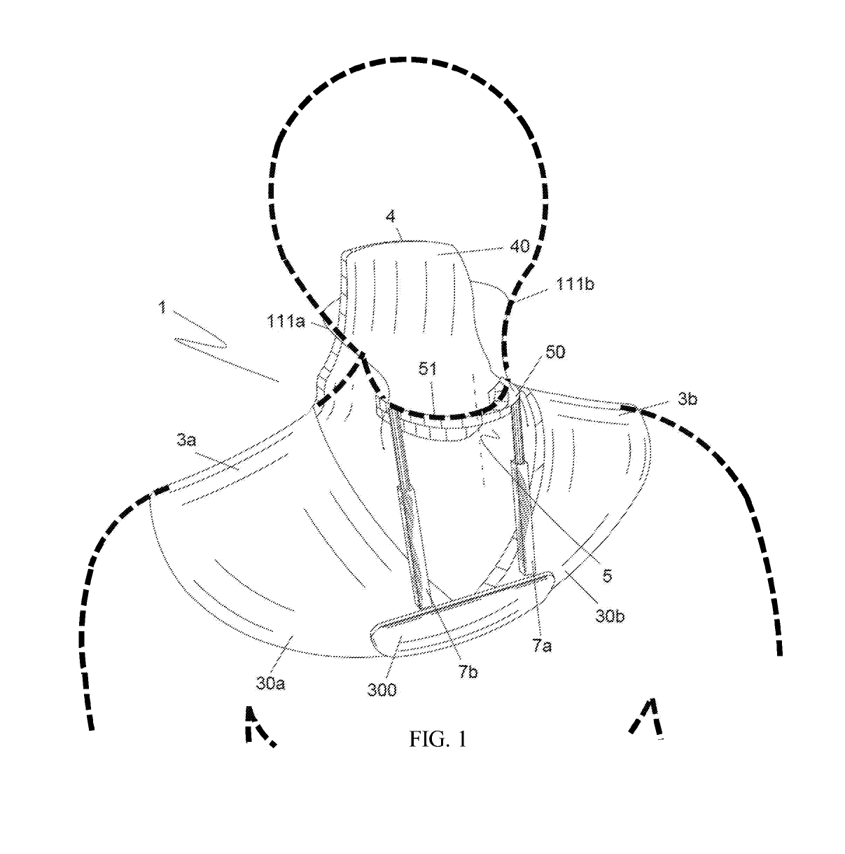

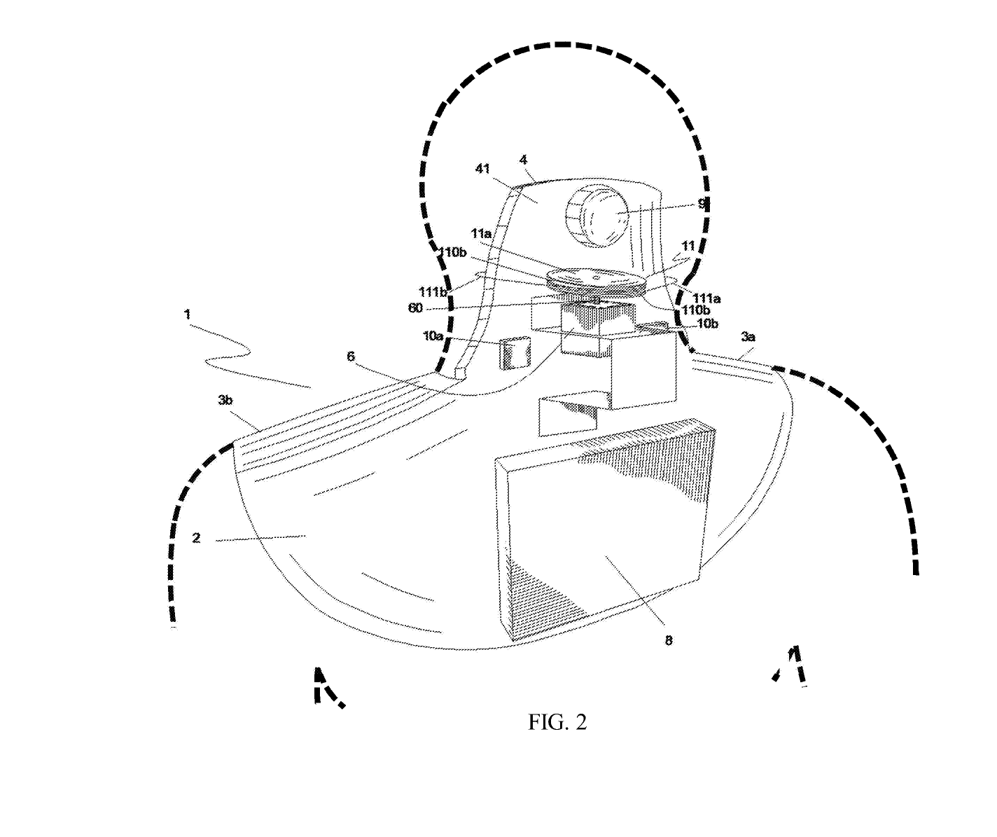

FIGS. 1 and 2 illustrate a portable neck treatment device 1, configured in accordance with embodiments of the present disclosure, which helps in alleviating neck pain associated with cervical disc in humans. (An outline of the upper body of a potential patient for the device 1 is represented in FIGS. 1 and 2 by the heavy dashed lines.) The device 1 includes a back support 2 with a first (e.g., right) shoulder engaging portion 3a and a second (e.g., left) shoulder engaging portion 3b extending therefrom. A head pad 4 has a front surface 40 and a back surface 41. The head pad 4 may be connected to the back support 2, at least one rotary actuator 6, two or more linear actuators 7a and 7b, and a control box 8. The device 1 may further include a jaw brace 5 with a right hand side portion 51 and a left hand side portion 50, a vibrator 9, and one or more heating elements 10a, 10b.

Each of the first and second shoulder engaging portions 3a, 3b may, in embodiments of the present disclosure, include a strap 30a, 30b, respectively. Such first and second straps 30a, 30b may be configured to partially or substantially cover the patient's shoulders and chest in a configuration suitable to help maintain the device 1 in a static position during a treatment session (each of the patient's shoulders may be trapped between the back support 2 and either the first strap 30a or the second strap 30b while being in contact with one of the shoulder engaging portions 3a, 3b). The first and second straps 30a, 30b may be configured to be connected to a fastener 300, such as a fabric hook and loop fastener. Fastening the first and second straps 30a, 30b to the fastener 300 can stabilize the device 1 when operated and used by the patient. The head pad 4 may be configured to provide support to the patient's head and neck during a treatment session.

In embodiments of the present disclosure, the jaw brace 5 is configured to ensure that at least a part of the rear of the patient's head is always in contact with the front surface 40 of the head pad 4, and is configured to apply the required exercises to the patient's head during a treatment session. In some embodiments, the forces applied by the operation of the at least one rotary actuator 6 and the two or more linear actuators 7a and 7b may cause movement of the patient's neck.

In embodiments of the present disclosure, the back support 2, the first and second shoulder engaging portions 3a, 3b, the first and second straps 30a, 30b, the head pad 4, and the jaw brace 5 may be made of a rigid or a flexible material or a combination of both.

In embodiments of the present disclosure, the at least one rotary actuator 6 and the two or more linear actuators are configured to cause the jaw brace 5 to apply traction and stretching exercises to a patient's neck.

In some embodiments, the at least one rotary actuator 6 is configured to rotate a patient's head such that the patient's jaw comes in proximity with one of the patient's shoulders, thus applying stretching therapy to the patient's neck.

In some embodiments, a concurrent operation of the two or more linear actuators 7a, 7b tilts the patient's head back towards the patient's back, thus applying traction therapy to the patient's neck.

In some embodiments, an operation of either of the two or more linear actuators 7a, 7b moves the patient's head towards one of the patient's shoulders, thus applying stretching therapy to the patient's neck.

In some embodiments, the at least one rotary actuator 6 may include a stepper motor with a suitable coupling mechanism 11. The coupling mechanism may include a pulley 11a with a first groove 110a and a second groove 110b, wherein each of such grooves may be associated with a cable 111a, 111b respectively, wherein the first cable 111a may be configured to be wound over the first groove 111a and the second cable may be configured to be wound over the second groove 111b. The first and second cables 111a, 111b mechanically connect the jaw brace 5 to the rotary actuator 6, wherein the first cable 111a is connected to the right-hand side 51 of the jaw brace 5 and the second cable 111b is connected to the left-hand side 50 of the jaw brace 5, such that the rotation of the rotary actuator 6 in a certain direction will pull one of the cables 111a, 111b in that direction, thereby the jaw brace 5, and, as a result, the patient's head will be rotated in that direction accordingly.

The pulley 11 may be connected to a central shaft 60 of the at least one rotary actuator 6.

In some embodiments of the present disclosure, the configuration of the pulley 11a, the first and second grooves 110a, 110b, as well as the first and second cables 111a, 111b, dictates that only one of such cables is subjected to a tensile force at any moment.

In some embodiments, the two or more linear actuators 7a, 7b may be configured to include a piston that is configured to reciprocate inside a pneumatic/hydraulic cylinder.

In some embodiments, each of the two or more linear actuators 7a,7b may be directly connected to the jaw brace 5, such that the linear actuator 7a is separably connected to the left-hand portion 50 and the linear actuator 7b is connected to the right-hand portion 51 of the jaw brace 5.

It should be appreciated that the device in some embodiments of the present disclosure may include further components configured to drive and ensure proper operation of the pneumatic/hydraulic cylinder, such as compressor, valves, etc. not shown for the sake of simplicity.

In some embodiments, the vibrator 9 and the one or more heating elements 10a, 10b may be configured to help in alleviating pain associated with a cervical disc.

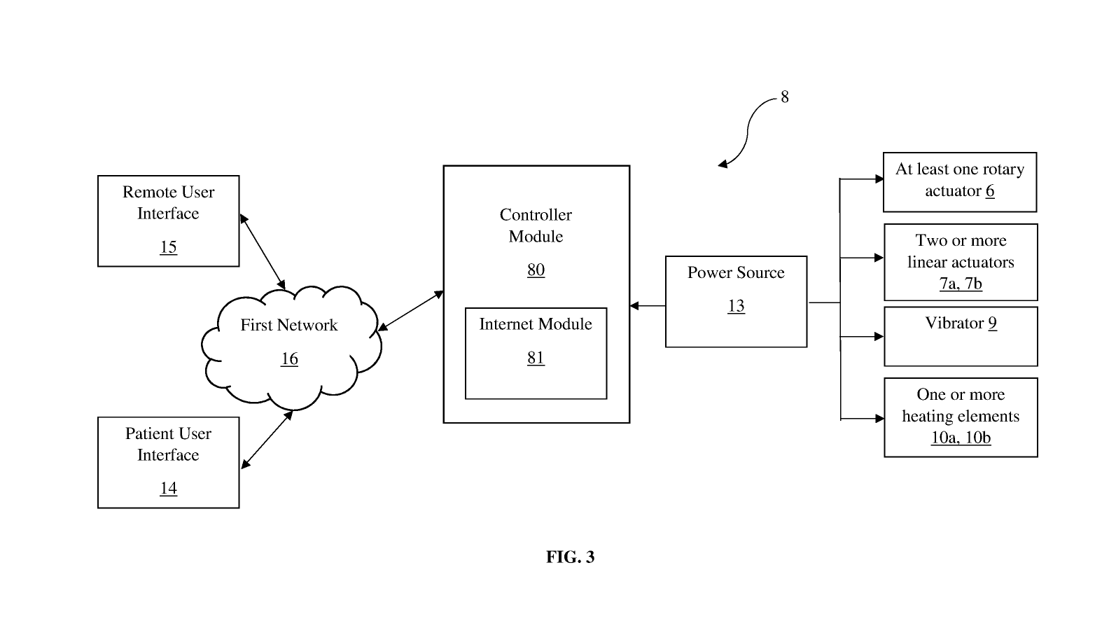

Referring to FIG. 3, in embodiments of the present disclosure, the control box 8 may include a controller module 80 with an internet module 81, wherein the controller module 80 may be configured to send operation signals to the at least one rotary actuator 6, the two or more linear actuators 7a, 7b, the vibrator 9, the one or more heating elements 10a, 10b, and the power source 13.

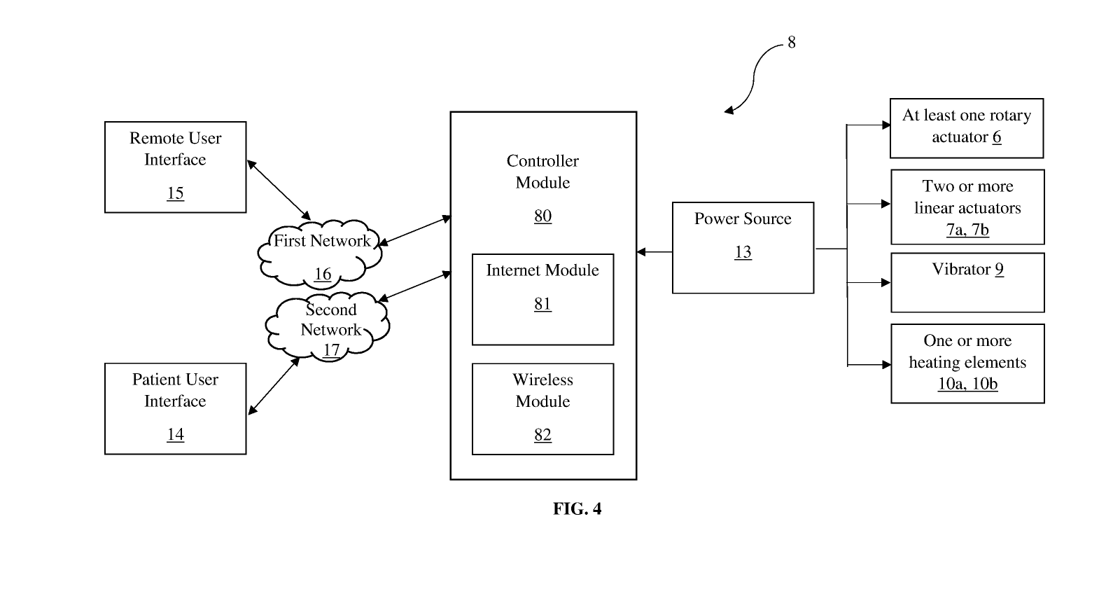

Referring to FIG. 4, in embodiments of the present disclosure, the internet module 81 may operably connect the controller module 80 to patient and remote user interfaces 14, 15, respectively, over a first network 16.

In other embodiments, the control box 8 may also include a wireless communication module 82, such as a Bluetooth or a Wi-Fi module, which may operably connect the controller module 80 to the patient user interface 14 over a second network 17. The second network may be a Bluetooth network, a Wi-Fi network, or any other wireless network.

The power source may include a rechargeable battery configured to provide suitable power levels to operate the components of the device 1.

The controller module 80 may be configured to send and receive signals from the patient and remote user interfaces 14, 15 over the first network 16 through the internet module 81. The remote user interface 15 may be configured to enable a remote user, such as a physiotherapist, or other medical professional, to remotely select the suitable type and duration of any of the aforementioned therapies and exercises, and may be configured as a web-based or a smart device application (including, but not limited to smartphone or tablet computer application), while the patient user interface may be configured to enable the patient to control the operation of the device 1 and to send feedback to the remote user on the exercise. In some embodiments, the patient user interface 15 may be configured as an application on a smart device (including, but not limited to smartphone or tablet computer application).

In some embodiments, the remote and/or patient user interfaces may be implemented on an internet-of-things (“IoT”) platform.

In other embodiments, the controller module 80 may be configured to send and receive signals from the patient and remote user interfaces 14, 15, respectively, over the second and first networks 16, 17, respectively, through the internet and wireless modules 81, 82. The remote user interface 15 may be configured to enable the remote user to select the suitable type and duration of therapies and exercises remotely and may be configured as a web-based or a smart device application (including, but not limited to smartphone or tablet computer application), while the patient user interface 14 may allow the patient to control the operation of the device 1 and to send feedback to the remote user on the exercise. In some embodiments, the patient user interface 15 may be deployed as a web-based or a smart device application (including, but not limited to smartphone or tablet computer application).

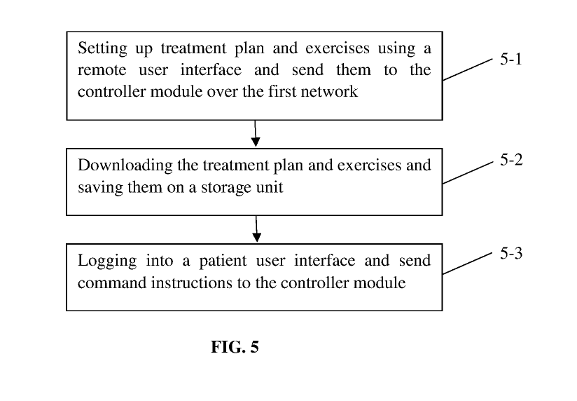

FIG. 5 illustrates a flowchart diagram of a process for setting up a treatment plan and/or exercises for a particular patient on the device 1 in accordance with various embodiments of the present disclosure. In such a process, a remote user (e.g., a medical professional) using the remote user interface 15 sets up the physical exercises and/or treatment plan and sends them over the first network 16 to the controller module 80 (process block 5-1). Then, the controller module 80 downloads the exercises' parameters and/or treatment plan, and may save them on a storage unit associated with the controller module 80 (process block 5-2). A patient logs into the patient user interface 14 that connects to the controller module 80 of the device 1 via the first network 16 (see FIG. 3) or the second network 17 (see FIG. 4) and can send control commands to the controller module 80 to control the operation of the device 1 (control commands include, but are not limited to, stop, pause, and start) (process block 5-3) in accordance with the downloaded treatment plan and/or exercises.

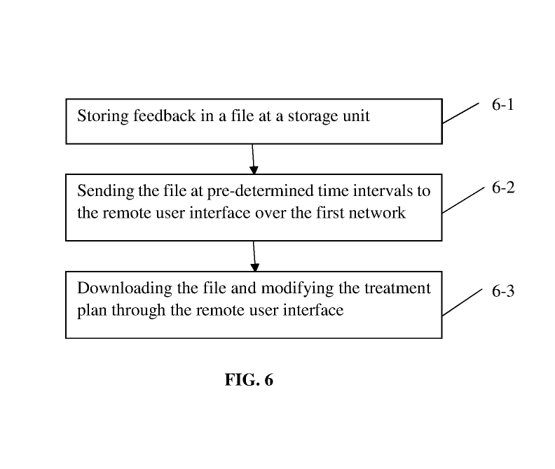

FIG. 6 illustrates a flowchart diagram of a process for providing feedback to a remote user (e.g., a medical professional) during or after the termination of the physical exercises and/or treatment plan, wherein the process includes storing reads of the rotary and linear actuators (such as rotation angle of the rotary actuator 6 and height(s) of the linear actuator(s) 7a, 7b, and/or temperatures of the heating elements 10a, 10b in a file at the storage unit (process block 6-1). Then, the file is sent by the controller module 80 (e.g., at pre-defined time intervals) to the remote user interface 15 over the first network 16 (process block 6-2). After that, the remote user (e.g., a medical professional) may view or download the feedback through the remote user interface 15 and can modify the treatment plan/exercise (process block 6-3).

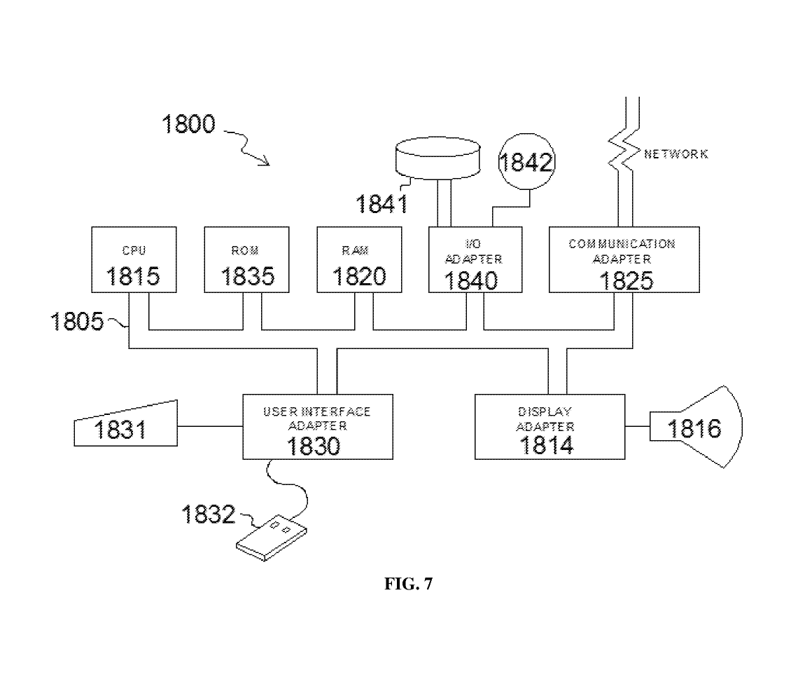

FIG. 7 illustrates an example of a data processing system 1800 for implementing various aspects of the present disclosure such as the remote user interface 15, the patient user interface 14, the controller module 80, and/or the processes disclosed with respect to FIGS. 5 and 6.

The computer system 1800 may employ a local bus 1805, such as a PCI bus, or some other bus architectures such as Accelerated Graphics Port (“AGP”) and Industry Standard Architecture (“ISA”), among others. The processor (“CPU”) 1815, volatile memory (“RAM”) 1820, and non-volatile memory (“ROM”) 1835 may be connected to the local bus 1805 in any well-known manner (e.g., through a PCI Bridge (not shown), which may also include an integrated memory controller and cache memory for the processor 1815). Additional connections to the local bus 1805 may be made through direct component interconnections or through add-in boards. One or more communications adapter(s) 1825 (e.g., see the internet module 81) may be coupled to the local bus 1805. Such communications adapter(s) 1825 provide one or more communication channel(s) between the computer system 1800 and one or more networks (e.g., the first and second networks 16, 17).

A user interface adapter 1830 may provide a connection for a keyboard 1831 and a mouse 1832 (and any other well-known user interface devices). An I/O adapter 1840 may provide a connection for a hard disk drive 1841, a tape drive 1842, and a CD-ROM drive (not shown) and any other well-known storage devices, such as those previously mentioned. A display adapter 1814 coupled to the local bus 1805 may be configured to operate a display device 1816.

The depicted example in FIG. 7 is not meant to imply architectural limitations. Further, a computer program form of the patient and/or remote user interfaces 14, 15 of the present disclosure may reside on any computer readable storage medium (i.e., floppy disk, compact disk, hard disk 1841, tape drive 1842, ROM 1835, RAM 1820, etc.) used by a computer system (e.g., the data processing system 1800). (The terms “data processing system,” “computer,” “system,” and “computer system” may be used interchangeably herein.)

Aspects of the present disclosure may be a system, a method, and/or a computer program product at any possible technical detail level of integration. Accordingly, aspects of the present disclosure may take the form of an entirely hardware embodiment, an entirely software embodiment (including firmware, resident software, micro-code, etc.), or embodiments combining software and hardware aspects that may all generally be referred to herein as a “circuitry,” “module,” or “system.” Furthermore, aspects of the present disclosure may take the form of a program product embodied in one or more computer readable storage medium(s) having computer readable program code embodied thereon. The computer program product may include a computer readable storage medium (or media) having computer readable program instructions thereon for causing a processor to carry out aspects of the present disclosure. (However, any combination of one or more computer readable medium(s) may be utilized. The computer readable medium may be a computer readable signal medium or a computer readable storage medium.)

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, the hard disk 1841, the RAM 1820, the ROM 1835, the tape drive 1842, an erasable programmable read-only memory (“EPROM” or Flash memory), a static random access memory (“SRAM”), a portable compact disc read-only memory (“CD-ROM”), a digital video disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network (e.g., see the first and second networks 16, 17). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of aspects of the present disclosure may be assembler instructions, instruction-set-architecture (“ISA”) instructions, machine instructions, machine dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages. The computer readable program instructions may execute entirely on the user's computer (e.g., the controller module 80 and/or the patient user interface 14), partly on the user's computer, as a stand-alone software package, partly on the user's computer and partly on a remote computer (e.g., the patient user interface 14 and/or the remote user interface 15), or entirely on the remote computer or server. In the latter scenario, the remote computer (e.g., the remote user interface 15) may be connected to the user's computer (e.g., the patient user interface 14) through any type of network (e.g., see the first and second networks 16, 17), including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) (e.g., see the controller module 80) may execute the computer readable program instructions by utilizing state information of the computer readable program instructions to personalize the electronic circuitry, in order to perform aspects of the present disclosure.

Aspects of the present disclosure have been described herein with reference to flowchart and/or block diagrams of methods, apparatus (systems), and computer program products according to embodiments of the present disclosure. It will be understood that some blocks of the block diagrams, and combinations of blocks in the block diagrams, can be implemented by computer readable program instructions.

These computer readable program instructions may be provided to a processor (e.g., the CPU 1815) of a general purpose computer, special purpose computer, or other programmable data processing apparatus to produce a machine (e.g., the system 1800), such that the instructions, which execute via the processor of the computer or other programmable data processing apparatus, create circuitry or means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagrams' block or blocks.

The flowchart and/or block diagrams in the Figures illustrate the architecture, functionality, and operation of possible implementations of systems, methods, and computer program products according to various embodiments of the present disclosure. In this regard, each block in the flowchart and/or block diagrams may represent a module, segment, or portion of instructions, which includes one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart diagrams, and combinations of blocks in the block diagrams and/or flowchart diagrams, can be implemented by special purpose hardware-based systems that perform the specified functions or acts or carry out combinations of special purpose hardware and computer instructions.

The use of the term “or” in the claims is used to mean “and/or” unless explicitly indicated to refer to alternatives only or the alternatives are mutually exclusive, although the disclosure supports a definition that refers to only alternatives and “and/or.” As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

Throughout this application, the terms “about” or “approximately” are used to indicate that a value includes the inherent variation of error for the device, the method being employed to determine the value, or the variation that exists among the study subjects. The singular forms “a,” “an,” and “the” include plural referents unless the context clearly dictates otherwise.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a defacto equivalent of any other member of the same list solely based on their presentation in a common group without indications to the contrary.

Any steps recited in any method or process claims may be executed in any order and are not limited to the order presented in the claims. Means-plus-function or step-plus function limitations will only be employed where for a specific claim limitation all of the following conditions are present in that limitation: a) “means for” or “step for” is expressly recited; and b) a corresponding function is expressly recited. The structure, material, or acts that support the means-plus function are expressly recited in the description herein. Accordingly, the scope of the invention should be determined solely by the appended claims and their legal equivalents, rather than by the descriptions and examples given herein.

What is claimed is:

1. A portable neck treatment device that can apply physical exercises to a patient's neck, the device comprising:
a back support;
a first shoulder engaging portion connected to the back support;
a second shoulder engaging portion connected to the back support;
a head pad extending from the back support with a front surface and a back surface;
a jaw brace mechanically connected to at least one rotary actuator using a suitable coupling mechanism, and to two or more linear actuators;
a patient user interface; and
a remote user interface, wherein the at least one rotary actuator, the two or more linear actuators, and the patient and remote user interfaces are operably connected to a controller module.

2. The portable neck treatment device of claim 1, wherein the back support supports a substantial part of a patient's back.

3. The portable neck treatment device of claim 1, wherein each of the first and second shoulder engaging portions contacts a patient's shoulders, and comprises a respective strap that covers a substantial part of a patient's chest during a therapeutic session.

4. The portable neck treatment device of claim 1, wherein the jaw brace encounters a patient's lower jaw, and wherein the at least one rotary actuator and the two or more linear actuators cause confined movements of the jaw brace.

5. The portable neck treatment device of claim 4, wherein the at least one rotary actuator comprises a stepper motor.

6. The portable neck treatment device of claim 4, wherein the two or more linear actuators comprise hydraulic reciprocating cylinders.

7. The portable neck treatment device of claim 1, wherein the suitable coupling mechanism comprises:
a pulley with a first groove and a second groove, the pulley connected to a shaft of the at least one rotary actuator;
a first cable engaged with the first groove and to a right-hand side of the jaw brace; and
a second cable engaged with the second groove and to a left-hand side of the jaw brace.

8. The portable neck treatment device of claim 7, wherein rotation of the pulley pulls either one of the first and second cables.

9. The portable neck treatment device of claim 1, wherein the vibrator and the one or more heating elements are positioned at the rear surface of the head pad.

10. The portable neck treatment device of claim 1, wherein the remote user interface is operably connected to the controller module via an internet module over a first network.

11. The portable neck treatment of claim 1, wherein the patient user interface is operably connected to the controller module via an internet module over a first network.

12. The portable neck treatment of claim 1, wherein the patient user interface is operably connected to the controller module via a wireless module over a second network.

13. The portable neck treatment device of claim 1, further comprising a vibrator positioned on the head pad.

14. The portable neck treatment device of claim 1, further comprising one or more heating elements positioned on the head pad.

15. The portable neck treatment device of claim 12, wherein the wireless module comprises a Bluetooth module.

16. The portable neck treatment device of claim 12, wherein the wireless module comprises a Wi-Fi module.

17. The portable neck treatment device of claim 1, wherein the controller module is configured to send and receive signals from the patient user interface and the remote user interface.

18. The portable neck treatment device of claim 1, wherein the controller module is configured to send operation control signals to the at least one rotary actuator, the two or more linear actuators, the vibrator, and the one or more heating elements.

19. The portable neck treatment device of claim 1, wherein the remote user interface enables a remote user to pre-program the controller module, set up a treatment plan and duration, and review a patient's feedback on a treatment session.

20. The portable neck treatment device of claim 1, wherein the patient user interface enables a patient to control an operation state of the device, and send feedback on a treatment session to a remote user.
